(19) United States
(12) Patent Application Publication
(10) Pub. No.: US 2006/0083117 A1
(43) Pub. Date: Apr. 20, 2006

(54) Certified protection from subliminal content for recordings

(76) Inventor: Timothy Raymond Cronin, Portage, WI (US)

Correspondence Address: Timothy Raymond Cronin, P.O. Box 291, Portage, WI, 53901, US

(21) Appl. No.: 10/680,830

(22) Filed: Oct. 7, 2003

(51) Int. Cl. G11B 21/08

(52) U.S. Cl. 369/30.01

(57) ABSTRACT

Piracy of audio recordings, recordings containing both audio and video content, and visual recordings is a big challenge to those who own the original intellectual property contained in those recordings. Technical means of preventing or interfering with unauthorized copying of that intellectual content has failed to prevent serious economic damage to the recording industry and to many artists who rely on it. I propose that by certifying specific lack of subliminal content the owners of the intellectual property will be able to appeal to potential purchasers who care about recordings' quality and who will pay for that quality. All subsequent copies of those recordings would lack that quality; and, consequently, would have lower market value.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The sales of audio and video recordings have been declining due to theft of the information contained in those recordings. Theft which was enabled by widespread use of new technologies. My invention aims to increase the sales of audio and video recordings by adding a value to those recordings which cannot be easily copied

I am not aware of a prior art of this type in the recording industry. Other sellers of consumer products, such as foods, soaps, and pharmaceuticals, have long used relative better purity as a selling point for their products.

### BRIEF SUMMARY OF THE INVENTION

Certified verifiably subliminal-free audio and video recordings. That is, recordings offered for sale which are certified to contain only that information which is not meant to pass unnoticed into the subconscious of a person or of persons listening to or viewing the recording. By offering such certified recordings for sale, the recording industry might increase sales of their products.

### BRIEF DESCRIPTION OF THE SEVERAL VIEWS OF THE DRAWING

Not Applicable

### DETAILED DESCRIPTION OF THE INVENTION

Production of audio, or audio and video, or video recordings in a secure production environment and using verified subliminal-free master recordings in such a way as to make it possible for the manufacturer of copies of a recording or recordings to be able to certify that the recording or recordings so produced will be verifiably free of so-called subliminals. That is, free of information included in the recording or recordings which is not meant to be consciously perceptible by the average person who might listen to, listen to and view, or view the recording or recordings.

This invention differs from other attempts to reduce theft of the intellectual property content of recordings. It does not do this by adding information in either the form of security features or extra-value content to copies of recordings. Nor does it do so by reducing the price of the recordings. But by certifying that copies' content is verifiably free of a specific class of information, inherent theft-resistant value is added to each copy.

I perceive that the best method for my invention to be implemented by the recording industry would be for that industry to verify the exact content of information which it intends to make copies of. To protect that information so that no additions can be made to it. Then to securely control the production of recorded copies of that information: and to do so in a way that allows manufacturers of those recordings to certify that each copy would be verifiably free of any information which is not overtly and clearly specified as being part of the contents of each copy.

What I claim as my invention is:

1. Certified verifiable subliminal-free
audio recordings,
recordings containing both audio and video content,
and visual recordings.
